(19) United States
(12) Patent Application Publication
(10) Pub. No.: US 2008/0137220 A1
(43) Pub. Date: Jun. 12, 2008

(54) Light refracting device

(76) Inventor: Yar-Chang Chiang, Tainan Hsien (TW)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/634,452

(22) Filed: Dec. 6, 2006

(51) Int. Cl. G02B 5/04

(52) U.S. Cl. 359/837

(57) ABSTRACT

A light refracting device includes: a mounting seat adapted for mounting at least one LED thereon; and at least one transparent cap mounted on the mounting seat and adapted to be capped on the LED. The cap defines an inner space and has a dome-shaped end portion that has a curved inner surface formed with a plurality of refracting protrusions protruding into the inner space for refracting light therethrough into the environment, and a plurality of recesses disposed alternately with the protrusions.

### BACKGROUND OF THE INVENTION

1. Field of the Invention

The invention relates to a light refracting device, more particularly to a light refracting device including a cap with an inner surface that is formed with refracting protrusions.

2. Description of the Related Art

Conventional car lighting devices, such as a headlight, a fog light, a brake light, etc., normally include a reflector and/or a lens for directing or focusing light into the environment. However, there is still a need to design a refracting device having light directing capability, a low manufacturing cost, and a simple structure for the car lighting device, particularly, when the light source is an LED, which is similar to a point source and which scatters light in all directions.

### SUMMARY OF THE INVENTION

Therefore, the object of the present invention is to provide a light refracting device that can be manufactured at a low cost and that has a simple structure.

Accordingly, a light refracting device of the present invention comprises: a mounting seat adapted for mounting at least one light-emitting unit thereon; and at least one transparent cap mounted on the mounting seat and adapted to be capped on the light-emitting unit. The cap defines an inner space, and has a dome-shaped end portion that has a curved inner surface formed with a plurality of refracting protrusions protruding into the inner space for refracting light therethrough into the environment, and a plurality of recesses disposed alternately with the refracting protrusions.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary, partly cutaway, exploded perspective view of the preferred embodiment of a light refracting device according to the present invention; and

FIG. 2 is a fragmentary assembled sectional view of the preferred embodiment.

### DETAILED DESCRIPTION OF THE PREFERRED EMBODIMENT

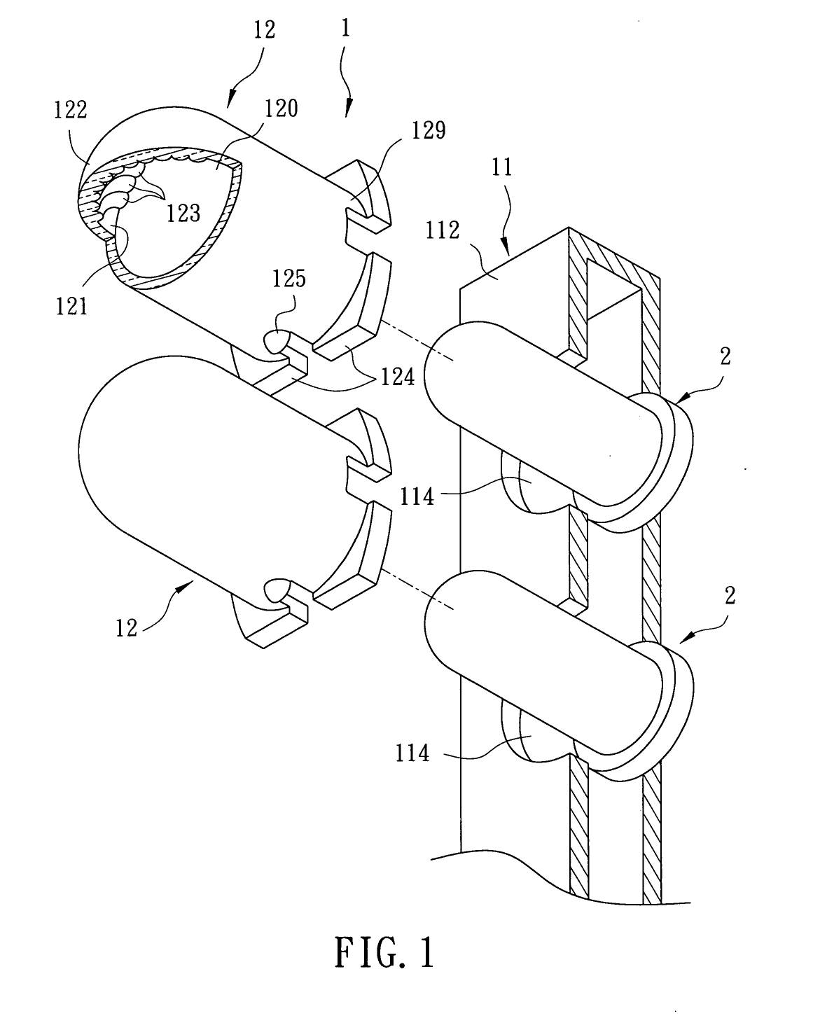

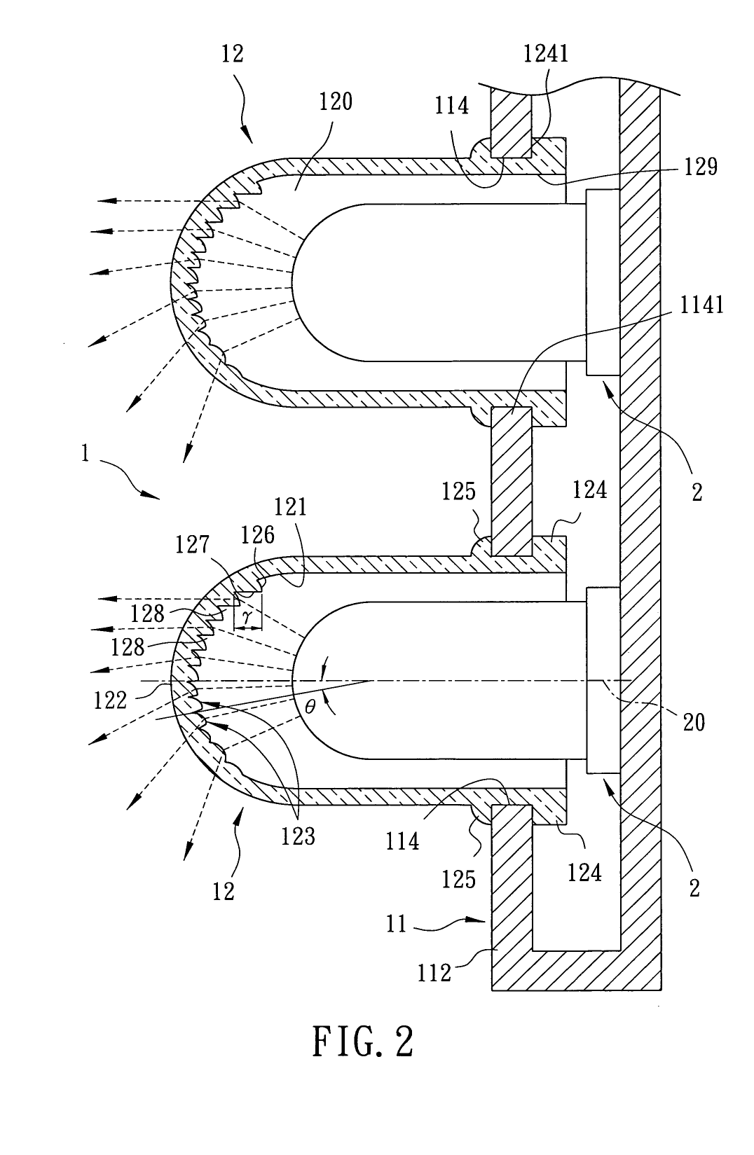

FIGS. 1 and 2 illustrate the preferred embodiment of a light refracting device 1 for a car lighting device according to the present invention. The light refracting device 1 includes: a mounting seat 11 adapted for mounting at least one light-emitting unit 2, such as an LED, thereon; and at least one transparent cap 12 (two are shown in this embodiment) mounted on the mounting seat 11 and adapted to be capped on the light-emitting unit 2, the cap 12 defining an inner space 120 and having a dome-shaped end portion 122 that has a curved inner surface 121 formed with a plurality of refracting protrusions 123 protruding into the inner space 120 for refracting light therethrough into the environment, and a plurality of recesses 128 disposed alternately with the refracting protrusions 123.

Referring to FIG. 2, each of the refracting protrusions 123 has a surface that has a curved portion 126 and a flat portion 127. The cap 12 defines a horizontal center plane 20. The refracting protrusions 123 are divided by the horizontal center plane 20 into upper refracting protrusions 123 and lower refracting protrusions 123. The flat portions 127 of the surfaces of the upper refracting protrusions 123 are substantially parallel to the horizontal center plane 20, whereas the flat portions 127 of the surfaces of the lower refracting protrusions 123 are inclined relative to the horizontal center plane 20 by an angle θ which is gradually increased from an uppermost one of the lower refracting protrusions 123 toward a lowermost one of the lower refracting protrusions 123. Moreover, the flat portion 127 of the surface of each of the upper refracting protrusions 123 has a length γ that extends in a direction substantially parallel to the horizontal center plane 20, and that is gradually decreased from an uppermost one of the upper refracting protrusions 123 toward a lowermost one of the upper refracting protrusions 123.

The mounting seat 11 has a mounting wall 112 transverse to the horizontal center plane 20 and formed with at least one mounting hole 114 (in this embodiment, two are shown). The mounting holes 114 can be circular, oval or rectangular in shape. The cap 12 has a mounting end 129 opposite to the dome-shaped end portion 122 and formed with an end flange 124. Each of the caps 12 is further formed with a plurality of angularly spaced apart retaining protrusions 125 that cooperate with the end flange 124 to define a gap 1241 therebetween. The cap 12 extends through the respective mounting hole 114 in such a manner that a periphery 1141 of the mounting hole 114 is received fittingly in the gap 1241.

The light-emitting unit(s) 2 is electrically connected to a circuit board (not shown) mounted on the mounting seat 11.

With the inclusion of the refracting protrusions 123 in the light refracting device 1 of this invention, the light emitted from the light-emitting unit(s) 2 can be efficiently collected and directed to a desired direction, such as a direction toward the ground, as best illustrated in FIG. 2, so as to enhance road visibility during night driving.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light refracting device comprising:
a mounting seat adapted for mounting at least one light-emitting unit thereon; and
at least one transparent cap mounted on said mounting seat and adapted to be capped on the light-emitting unit, said cap defining an inner space and having a dome-shaped end portion that has a curved inner surface formed with a plurality of refracting protrusions protruding into said inner space for refracting light therethrough into the environment, and a plurality of recesses disposed alternately with said refracting protrusions.

2. The light refracting device as claimed in claim 1, wherein each of said refracting protrusions has a surface that has a curved portion and a flat portion.

3. The light refracting device as claimed in claim 2, wherein said cap defines a horizontal center plane, said refracting protrusions being divided by the horizontal center plane into upper refracting protrusions and lower refracting protrusions, said flat portions of said surfaces of said upper refracting protrusions being substantially parallel to the horizontal center plane, said flat portions of said surfaces of said lower refracting protrusions being inclined relative to the horizontal center plane.

4. The light refracting device as claimed in claim 3, wherein said flat portion of said surface of each of said lower refracting protrusions is inclined relative to the horizontal center plane by an angle, said angle being gradually increased from an uppermost one of said lower refracting protrusions toward a lowermost one of said lower refracting protrusions.

5. The light refracting device as claimed in claim 3, wherein said flat portion of said surface of each of said upper refracting protrusions has a length extending in a direction substantially parallel to the horizontal center plane, said length being gradually decreased from an uppermost one of said upper refracting protrusions toward a lowermost one of said upper refracting protrusions.

6. The light refracting device as claimed in claim 3, wherein said mounting seat has amounting wall transverse to the horizontal center plane and formed with at least one mounting hole, said cap further having a mounting end opposite to said dome-shaped end portion and formed with an end flange, said cap being formed with a plurality of angularly spaced apart retaining protrusions that cooperate with said end flange to define a gap therebetween, said cap extending through said mounting hole in such a manner that the periphery of said mounting hole is received fittingly in said gap.
